(19) United States
(12) Patent Application Publication
(10) Pub. No.: US 2011/0222849 A1
(43) Pub. Date: Sep. 15, 2011

(54) OPTICAL TRANSMISSION APPARATUS FOR VISIBLE LIGHT COMMUNICATION

(75) Inventors: Sang-Kyoo HAN, Daejeon (KR); Sung-Soo Hong, Seoul (KR); Byung-Jun Jang, Seoul (KR); Chung-Wook Roh, Seoul (KR)

(73) Assignee: KOOKMIN UNIVERSITY INDUSTRY-ACADEMIC COOPERATION FOUNDATION, Seoul (KR)

(21) Appl. No.: 13/004,099

(22) Filed: Jan. 11, 2011

(30) Foreign Application Priority Data
Mar. 12, 2010 (KR) 10-2010-0022396

(51) Int. Cl. H04B 17/00

(52) U.S. Cl. 398/25

(57) ABSTRACT

Disclosed herein is an optical transmission apparatus for visible light communication. The optical transmission apparatus includes a power conversion unit, a drive unit, an encoding unit, a control unit, and a detection unit. The power conversion unit provides Direct Current (DC) power to the lighting LED lamps. The drive unit is operated using a switching drive method and supplies operating current to the lighting LED lamps. The encoding unit is connected to an external network, receives and encodes data, and provides it to the drive unit. The control unit controls the operation of the power conversion unit, the drive unit, and the encoding unit. The detection unit measures the strength of a visible light signal sent by the lighting LED lamps.

### CROSS-REFERENCE TO RELATED APPLICATION

This application claims priority to and the benefit of Korean Patent Application No. 10-2010-0022396 filed in the Korean Intellectual Property Office on Mar. 12, 2010, the entire contents of which are incorporated herein by reference.

### BACKGROUND OF THE INVENTION

1. Field of the Invention

The present invention relates generally to an optical transmission apparatus for visible light communication using a plurality of Light-Emitting Diode (LED) lamps, and, more particularly, to an optical transmission apparatus for visible light communication which enables high-speed data communication and provides high power conversion efficiency.

2. Description of the Related Art

Recently, as the light emission efficiency of Light-Emission Diodes (LEDs) has improved and the prices thereof have decreased, LEDs have been popularized not only in the special illumination fields of portable devices, displays, automobiles, signal lights and billboards but also in the general illumination fields of fluorescent lamps and incandescent lamps. In particular, the light emission efficiency of white LEDs has already surpassed incandescent lamps, and products superior to fluorescent lamps have been marketed. Furthermore, recently, since interest in optical wireless technology which complements Radio Frequency (RF) technology is increasing because of the exhaustion of the RF band frequencies, the possibility of interference between a variety of wireless communication technologies, the increase in demand for the security of communication, and the advent of a super-high speed ubiquitous communication environment based on 4G wireless technology, research into visible light wireless communication using visible light LEDs has been conducted in many companies and laboratories.

Visible light communication which is performed such that information is transferred using visual light which can be seen by humans has not only the advantage of having a wide useable band and being free of restrictions but also the advantage of enabling the range of reception of information to be accurately found because the place where light is generated and the direction in which light propagates can be seen.

The drive units of visible light communication optical transmission apparatuses having the above-described characteristics may be classified into a switching drive type and a linear drive type. A switching drive-type circuit includes a power conversion unit and a drive unit. The power conversion unit outputs a constant DC voltage, and the drive unit drives LEDs based on the DC voltage by using a switching mode DC/DC converter, such as a buck converter, a zeta converter, a cuk converter, a boost converter, or a flyback converter. A drive element, such as a MOSFET, a BJT, or an IGBT, used in the drive unit has the advantage of being very suitable for inexpensive, high-capacity LED drive circuits because it operates in a switching region and thus it has excellent power conversion efficiency and drive element heat emission characteristics. However, because of the slow dynamic characteristics of the switching mode DC/DC converter, the bandwidth of the switching drive method is several tens of kHz, and is too small to selectively turn on and off LED current at a high speed to perform data communication while maintaining the magnitude of the LED current at a constant value, so that it is disadvantageous in that when it is applied to visible light communication, it is difficult to implement data communication at a high speed of several or higher MHz. So far there is no instance where it is has been used for Visible Light Communication (VLC).

In spite of the existence of the switching drive method capable of providing high power conversion efficiency, the conventional technology cannot work with an optical transmission apparatus based on a linear drive method because the above-described disadvantages cannot be overcome.

The linear drive-type circuit includes a power conversion unit and a drive unit. The linear drive-type circuit has the advantage of implementing high-speed data communication in such a way that the power conversion unit outputs a constant DC voltage and the drive unit operates a drive element, such as a switch, in a linear region, but has the disadvantage of having poor power conversion efficiency and poor drive element heat emission characteristics because current flows through LED lamps while the operating voltage is always being applied to the drive element which sends signals to the LED lamps, so that the manufacturing cost thereof is high and it is not suitable for high-capacity drive circuits.

Furthermore, in order to use the optical transmission apparatus for visible light communication for illumination, it should be possible to adjust the luminance of the LED lamps. Since the linear drive method cannot accurately control luminance and the switching drive method cannot control the peak value of current flowing through the LED lamps, the two drive methods have problems with the output of such luminance and also have problems with life span and reliability.

### SUMMARY OF THE INVENTION

Accordingly, the present invention has been made keeping in mind the above problems occurring in the prior art, and an object of the present invention is to provide an optical transmission apparatus for visible light communication which is capable of implementing high-speed data communication when visible light communication is performed.

Another object of the present invention is to provide an optical transmission apparatus for visible light communication which adopts a switching drive method, thereby providing high power conversion efficiency.

Still another object of the present invention is to provide an optical transmission apparatus for visible light communication which is equipped with an inexpensive high-capacity drive circuit having excellent power conversion efficiency and device heat emission characteristics.

Still another object of the present invention is to provide an optical transmission apparatus for visible light communication which is capable of increasing power conversion efficiency, thus contributing to energy conservation, which is an important current social issue.

In order to accomplish the above object, the present invention provides an optical transmission apparatus for visible light communication, the optical transmission apparatus for visible light communication performing visible light communication with an external optical reception apparatus by using a plurality of lighting LED lamps for emitting visible light as light sources, including a power conversion unit for providing DC power to the lighting LED lamps; a drive unit configured to be operated using a switching drive method and to supply operating current to the lighting LED lamps; an encoding unit connected to an external network, and configured to receive and encode data and provide it to the drive unit; a control unit for controlling operations of the power conversion unit, the drive unit, and the encoding unit; and a detection unit for measuring a strength of a visible light signal sent by the lighting LED lamps.

The power conversion unit may include a DC/DC converter which is capable of acquiring a desired output voltage or output current using pulse width modulation or pulse frequency modulation.

The drive unit may include a switching device, and may be configured to be connected to the lighting LED lamps in series.

The drive unit may be selectively turned on and off in response to the signal encoded by the encoding unit, and may thus be operated at a high speed in a switching region.

The detection unit may detect the strength of the visible light signal sent by the lighting LED lamps.

The detection unit may be located in front of or behind the output capacitor.

The adjustment of the luminance based on a user's command input to the control unit may be performed using any one of an analog method or a pulse width modulation method.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an optical transmission apparatus for visible light communication according to the present invention;

FIG. 2 is a block diagram of a first embodiment of the optical transmission apparatus for visible light communication shown in FIG. 1;

FIG. 3 is a block diagram of a second embodiment of the optical transmission apparatus for visible light communication shown in FIG. 1;

FIG. 4 is a block diagram showing the detailed configuration of a control unit;

FIG. 5 is a flowchart showing a method of controlling the power of an optical transmission apparatus for visible light communication according to the present invention;

FIG. 6 is a comparison diagram showing variations in current based on the analog-type adjustment of luminance;

FIG. 7 is a comparison diagram showing variations in current based on the Pulse Width Modulation (PWM)-type adjustment of luminance.

### DESCRIPTION OF THE PREFERRED EMBODIMENTS

Reference now should be made to the drawings, in which the same reference numerals are used throughout the different drawings to designate the same or similar components.

The configuration and operation of the embodiments of the present invention will be described below with reference to the accompanying drawings.

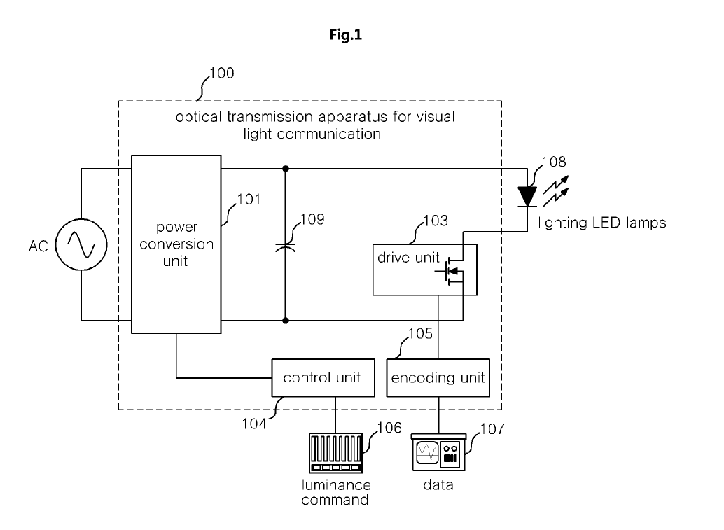

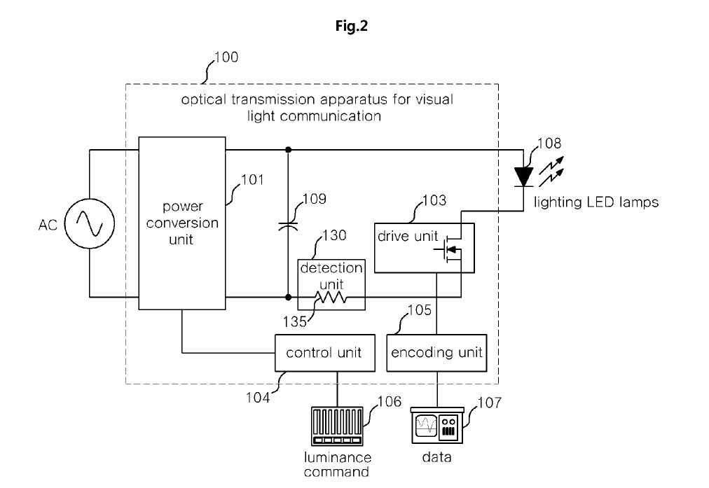

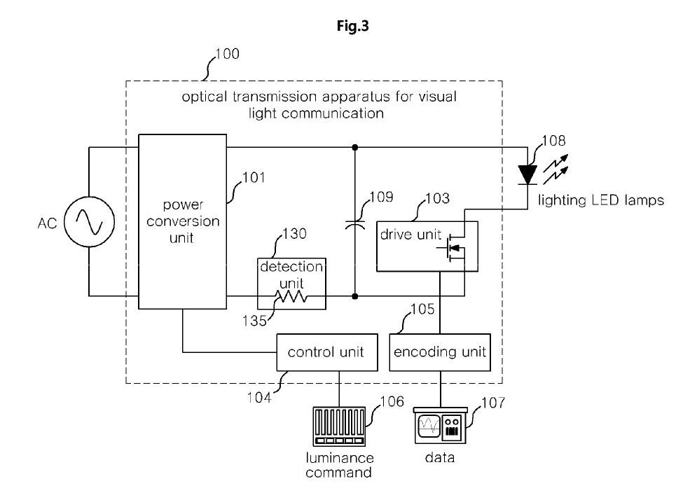

FIG. 1 is a block diagram of an optical transmission apparatus for visible light communication according to the present invention, FIG. 2 is a block diagram of a first embodiment of the optical transmission apparatus for visible light communication shown in FIG. 1, and FIG. 3 is a block diagram of a second embodiment of the optical transmission apparatus for visible light communication shown in FIG. 1.

As shown in FIG. 1, the optical transmission apparatus for visible light communication according to the present invention includes a power conversion unit 101, a drive unit 103, an encoding unit 105, and a control unit 104. The power conversion unit 101 performs AC/DC conversion, and then the above-described DC/DC converter performs conversion to the appropriate voltage or current required by the optical transmission apparatus for visible light communication 100.

FIG. 2 shows another embodiment of the optical transmission apparatus shown in FIG. 1, which additionally includes a detection unit 130 which is used to adjust the luminance of LED lamps 108 used for lighting (“lighting LED lamps”) in compliance with a user's luminance command 106.

The power conversion unit 101 of the optical transmission apparatus for visible light communication 100 according to the present invention and an output capacitor 109 are connected in parallel. The drive unit 103 and the lighting LED lamps 108 are connected in series, and the drive unit 103 and the lighting LED lamps 108, which are connected in series, and the output capacitor 109 are connected in parallel.

The optical transmission apparatus for visible light communication 100 additionally includes a detection unit 130 which is used to adjust the luminance of the lighting LED lamps 108 in compliance with a user's luminance command 106. The detection unit 130 is placed in front of or behind the output capacitor 109.

The power conversion unit 101 of the optical transmission apparatus for visible light communication 100 includes an AC/DC converter and a DC/DC converter. The DC/DC converter includes any type of DC/DC converter that performs pulse width modulation or pulse frequency modulation, including a buck converter, a zeta converter, a cuk converter, a boost converter, and a flyback converter, to perform conversion to the appropriate voltage or current required by the optical transmission apparatus for visible light communication 100 according to the present invention.

The drive unit 103 of the optical transmission apparatus for visible light communication 100 according to the present invention includes a switching device, and this switching device includes any type of switching device capable of high-speed switching, including a MOSFET, a BJT, an IGBT, a JFET, an HEMPT, an SCR, and a thyristor. Here, “high-speed switching” refers to about 2 Mbps switching in the case of voice signals and about 10 Mbps switching in the case of video signals. The detection unit 130 is formed of a resistor (a sensing resistor) 135 or a current sensor.

Since DC power is required to operate the lighting LED lamps 108 of the optical transmission apparatus for visible light communication 100, the power conversion unit 101 performs AC/DC conversion, and then the above-described DC/DC converter performs conversion to the appropriate voltage or current required by the optical transmission apparatus for visible light communication 100.

Data 107 received by the encoding unit 105 of the optical transmission apparatus for visible light communication 100 enters from an external network.

The encoding unit 105 encodes the data 107, received from the external network, into a digital signal which can be sent to the lighting LED lamps 108 in such a way that the switching device of the drive unit 103 performs an on/off operation in a switching area.

Here, the switching device of the drive unit 103 performs a high-speed switching operation at a speed of about 2 Mbps if the signal encoded by the encoding unit 105 is a voice signal, or at a speed of 10 Mbps if the signal encoded by the encoding unit 105 is a video signal.

If the signal encoded by the encoding unit 105 is high ‘1,’ the switch of the drive unit 103 passes electricity therethrough and thus all of the output current of the power conversion unit 101 flows to the switch, so that the lighting LED lamps 108 are turned on. In contrast, if the signal encoded by the encoding unit 105 is low ‘0,’ the switching device of the drive unit 103 is opened and thus the output current of the power conversion unit 101 flows only to the output capacitor 109, so that the lighting LED lamps 108 are turned off. As described above, visible light communication with an external optical reception apparatus is performed in such a way that the lighting LED lamps repeat an on/off operation in response to the signal encoded by the encoding unit 105.

Even when the lighting LED lamps 108 of the optical transmission apparatus for visible light communication according to the present invention repeat the on/off operation, the on/off operation is performed at a high speed which prevents the operation from being sensed by the human eye, so that the optical transmission apparatus for visible light communication 100 according to the present invention can be used for illumination. Human eyes cannot sense 100 or more flickers per second.

When the present invention is used for illumination at home or in an office, the detection unit 130 of the optical transmission apparatus for visible light communication 100 detects the strength of a visible light signal, sent by the lighting LED lamps 108, to adjust the luminance of the lighting LED lamps 108 in response to the user's luminance command 106 to adjust the brightness of illumination. The strength of a visible light signal is perceived based on the average magnitude of current which flows through the lighting LED lamps 108. For example, when the average magnitude of current is large, illumination is perceived to be bright by the human eye. The sensed strength of the visible light signal is sent to the control unit 104. The magnitude of current which flows through the lighting LED lamps 108 and which is detected by the detection unit 130 has a constant value regardless of the operation of the drive unit 103. The detection unit 130 detects the strength of a visible light signal using a resistor (a sensing resistor) 135 or a current sensor in the form of a voltage.

FIG. 3 is a block diagram of a second embodiment of the optical transmission apparatus for visible light communication shown in FIG. 1.

Since the strength of the current of the output capacitor 109 of the power conversion unit 101 according to the present invention is ‘0’, the average value of the current of the lighting LED lamps 108 is the same as the average value of the output current of the power conversion unit 101, so that the detection unit 130 according to the present invention can be located in front of the output capacitor 109, as shown in FIG. 3. In particular, since the bandwidth of the control unit 104 which controls the power conversion unit 101 is narrower than the operating frequency of the drive unit 103, only the average value of the current of the lighting LED lamps 108 is controlled regardless of the operation of the drive unit 103.

Since the detection unit 130 and the control unit 104 perform the same operations as those of FIG. 2 except that the location of the detection unit 130 is different from that of FIG. 2, detailed descriptions thereof will be omitted here.

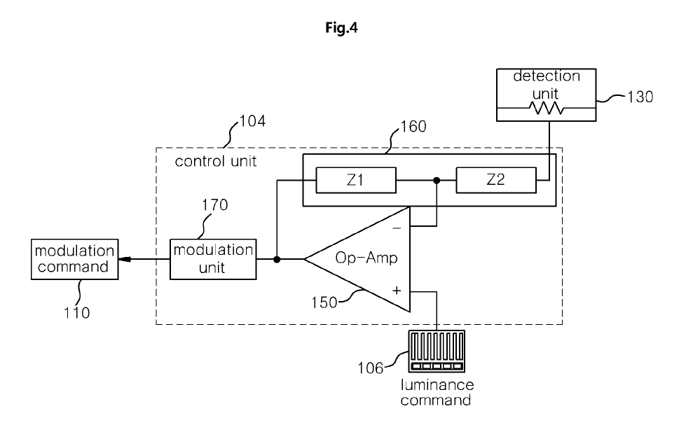

FIG. 4 is a block diagram showing the configuration of the control unit. As shown in FIG. 4, the control unit 104 of the present invention includes an operational amplifier 150, a controller 160, and a modulation unit 170. The magnitude of current which is detected by the detection unit 130 and which flows through the lighting LED lamps 108 has a constant value regardless of the operation of the drive unit 103, and the detection unit 130 detects the strength of a visible light signal using the resistor (sensing resistor) 135 in the form of voltage. Here, the controller 160 of the control unit 104 outputs the strength of the signal, detected by the detection unit 130, as an average value. A method of outputting the strength of a signal, detected by the detection unit 130, as an average value may be implemented using the controller's own integrator, or may be implemented by adding an averager between the operational amplifier 150 and the detection unit 130. Here, the averager includes any type of circuit which performs the function of a low pass filter.

The operational amplifier 150, the modulation unit 170, and the controller 160 included in the control unit 104 compares the user's luminance command 106 with the average voltage value of the strength of the visible light signal, and the power conversion unit 101 adjusts the current of the lighting LED lamps 108 so that the current of the lighting LED lamps 108 is equal to the value of the user's luminance command 106. Methods of adjusting the luminance of the lighting LED lamps 106 in compliance with the user's luminance command 106 include an analog-type luminance adjustment method and a PWM-type adjustment method. The methods of adjusting the luminance of the lighting LED lamps 106 in compliance with the user's luminance command 106 will be described later.

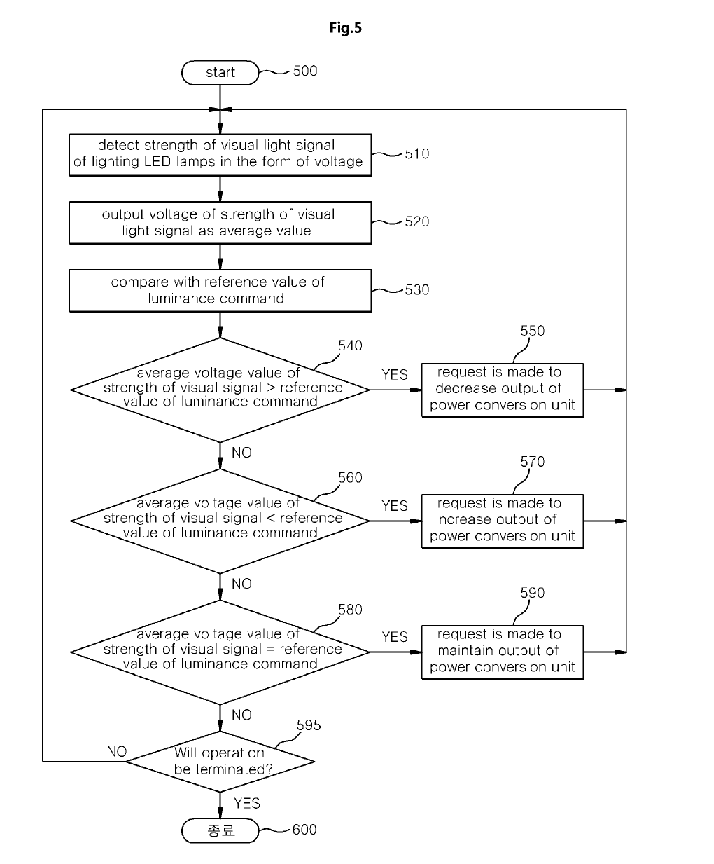

FIG. 5 is a flowchart showing a method of controlling the power of an optical transmission apparatus for visible light communication according to the present invention.

A method of controlling the power conversion unit 101 by comparing a user's luminance command 106 with the average voltage value of the strength of a visible light signal detected by the detection unit 130 will now be described.

The “strength of a visible light signal” refers to the brightness of LED lamps used for lighting (“lighting LED lamps”).

Accordingly, the measurement of the strength of visible light means a measurement of the brightness of lighting LED lamps, which has the same meaning as does a measurement of the luminance of lighting LED lamps.

Furthermore, the strength of a visible light signal is perceived based on the magnitude of current which flows through the lighting LED lamps. When the magnitude of the current is high, the strength of the visible light signal is high. Furthermore, when the strength of the visible light signal is high, the brightness of the lighting LED lamps is perceived to be high by the human eye.

Since the strength of the visible light signal of the optical transmission apparatus for visible light communication according to the present invention is proportional to the magnitude of current flowing through the lighting LED lamps, the strength of the visible light signal can be measured using current flowing through the lighting LED lamps without requiring an additional luminance sensor.

When the current flowing through the lighting LED lamps 108 flows through the resistor (sensing resistor) 135 or current sensor of the detection unit 130 according to the present invention, the detection unit 130 measures the current in the form of voltage.

Information about the measured voltage is input to the control unit 104, and is used to adjust the luminance or brightness of the lighting LED lamps 108 under the control of the control unit 104.

When the current flowing through the lighting LED lamps 108 flows through the resistor (sensing resistor) 135, voltage is applied between both ends of the resistor (sensing resistor) 135, and the voltage is detected and input to the control unit 104.

First, step 510 of detecting the strength of a visible light signal sent by the lighting LED lamps 108 in the form of voltage is performed. Thereafter, step 520 of outputting the strength of the visible light signal detected in the form of voltage at the above step as an average value is performed. Thereafter, step 530 of comparing the average value with a reference value based on a user's luminance command is performed.

After the comparison step 530, power control is requested from the power conversion unit based on comparison results, as follows:

i) if the average voltage value of the strength of the visible light signal detected at the above step is greater than a reference voltage based on the user's luminance command, a request is made to decrease the output of the power conversion unit at step 540;

ii) if the average voltage value of the strength of the visible light signal detected at the above step is less than a reference voltage based on the user's luminance command, a request is made to increase the output of the power conversion unit at step 560; and

iii) if the average voltage value of the strength of the visible light signal detected at the above step is equal to reference voltage based on the user's luminance command, a request is made to maintain the output of the power conversion unit at step 580.

In the following Table 1, the above-described power control method is summarized.

TABLE 1

| | | Average voltage value |
|---|---|---|
| Average voltage value | Average voltage value of | of strength of visible |
| of strength of visible | strength of visible | light signal = |
| light signal > | light signal < reference | reference voltage |
| reference voltage based | voltage based on | based on luminance |
| on luminance command | luminance command | command |
| Request is made to | Request is made to | Request is made to |
| decrease output of | decrease output of power | maintain output of |
| power conversion unit | conversion unit | power conversion unit |

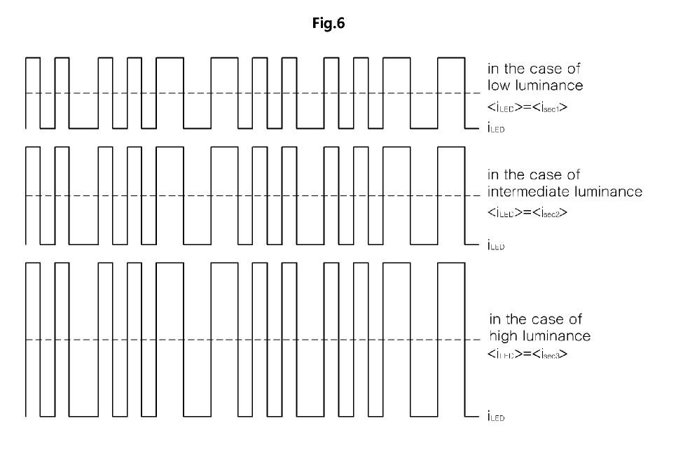

FIG. 6 is a comparison diagram showing variations in current based on the analog-type adjustment of luminance.

As shown in FIG. 6, when the optical transmission apparatus for visible light communication according to the present invention is used for illumination, the variations in current based on the analog-type adjustment of luminance are plotted.

The magnitude of the conducted current of the lighting LED lamps varies in compliance with a user's luminance command, and data may be carried in the front or rear portion of a conduction interval or over the entire interval. A user senses the average value of the conducted current of the lighting LED lamps as the luminance of the lighting lamp. Accordingly, if the conducted current is high, the average value increases, so that the user senses that the luminance of the lighting lamp become high. In contrast, if the magnitude of the conducted current is small, the average value decreases, so that the user senses that the luminance of the lighting lamp become low.

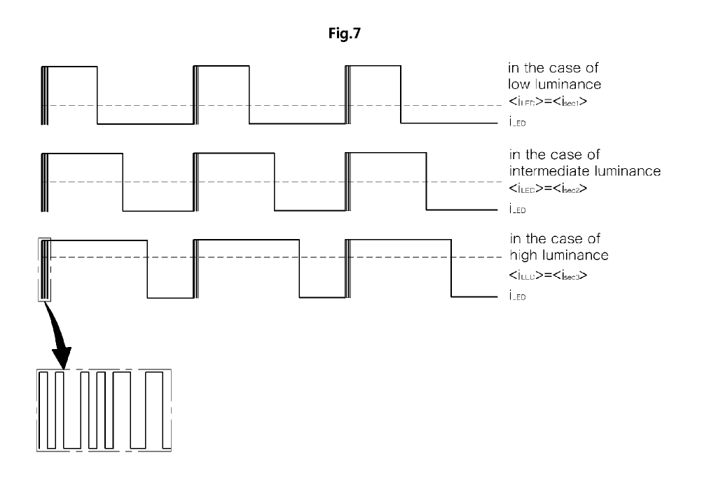

FIG. 7 is a comparison diagram showing variations in current based on the PWM-type adjustment of luminance. As shown in FIG. 1, in the optical transmission apparatus for visible light communication according to the present invention, the conduction interval of the current of the lighting LED lamps varies in compliance with a user's luminance command, and data is carried in the front or rear portion of the conduction interval. Since a user senses the average value of the conducted current of the lighting LED lamps as the luminance of the lighting lamp, the average value increases in proportion to the increase in the conduction interval of the conducted current, so that a user senses that the luminance of the lighting light become high. In contrast, if the conduction interval of the conducted current is short, the average value decreases, so that a user senses that the luminance of the lighting lamp becomes low.

Since the drive element of the drive unit of the above-described optical transmission apparatus for visible light communication according to the present invention is operated using a switching drive method, the optical transmission apparatus for visible light communication has excellent power conversion efficiency and device heat emission characteristics. Furthermore, since the drive unit of the lighting LED lamps, which is separate from the power conversion unit, is provided, the drive element can be operated using a high-frequency switching drive method, so that high-speed data communication is enabled.

Furthermore, in accordance with the method of controlling the power of the optical transmission apparatus for visible light communication according to the present invention, the luminance of the lighting LED lamps can be adjusted in compliance with a user's command, so that it is very suitable for a lighting apparatus.

Furthermore, the optical transmission apparatus for visible light communication according to the present invention does not interfere with existing radio wave communications. Accordingly, data can be transferred using the visible light communication apparatus of the present invention in a hospital and airplane in which the erroneous operation of equipment may occur due to interference between radio waves. Furthermore, since the optical transmission apparatus for visible light communication according to the present invention can be installed in visual light lighting apparatuses, it can be installed and used in offices, indoor areas and living spaces where lighting lamps are installed. Accordingly, the optical transmission apparatus for visible light communication according to the present invention can replace existing lighting lamps, and can additionally provide data communication functionality, so that it can be used as a terminal device which provides home networking and ubiquitous communication service.

Furthermore, the optical transmission apparatus for visible light communication according to the present invention can improve power conversion efficiency, thus contributing to energy conservation, which is an important current social issue.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical transmission apparatus for visible light communication, the optical transmission apparatus for visible light communication performing visible light communication with an external optical reception apparatus by using a plurality of lighting Light-Emitting Diode (LED) lamps for emitting visible light as light sources, comprising:
a power conversion unit for providing Direct Current (DC) power to the lighting LED lamps;
a drive unit configured to be operated using a switching drive method and to supply operating current to the lighting LED lamps;
an encoding unit connected to an external network, and configured to receive and encode data and provide it to the drive unit;
a control unit for controlling operations of the power conversion unit, the drive unit, and the encoding unit; and
a detection unit for measuring a strength of a visible light signal sent by the lighting LED lamps.

2. The optical transmission apparatus as set forth in claim 1, wherein the power conversion unit comprises a DC/DC converter which is capable of acquiring a desired output voltage or output current using pulse width modulation or pulse frequency modulation.

3. The optical transmission apparatus as set forth in claim 1, wherein the drive unit comprises a switching device, and is configured to be connected to the lighting LED lamps in series.

4. The optical transmission apparatus as set forth in claim 1, wherein the drive unit is selectively turned on and off in response to a signal encoded by the encoding unit, and thus is operated at a high speed in a switching region.

5. The optical transmission apparatus as set forth in claim 1, wherein the detection unit detects the strength of the visible light signal, sent by the lighting LED lamps, that form of voltage.

6. The optical transmission apparatus as set forth in claim 1, wherein the detection unit is located in front of or behind an output capacitor.

7. The optical transmission apparatus as set forth in claim 1, wherein adjustment of luminance based on an user's command input to the control unit is performed using any one of an analog method or a pulse width modulation method.
